(19) United States
(12) Patent Application Publication
(10) Pub. No.: US 2024/0322882 A1
(43) Pub. Date: Sep. 26, 2024

(54) METHOD, APPARATUS AND COMPUTER PROGRAM FOR COMMUNICATING BETWEEN A BASE STATION AND A REPEATER

(71) Applicant: Nokia Technologies Oy, Espoo (FI)

(72) Inventors: Christian ROM, Aalborg (DK); Simon SVENDSEN, Aalborg (DK); Benny VEJLGAARD, Aalborg (DK); Morten TOFT, Aalborg (DK); Ali KARIMIDEHKORDI, Aalborg (DK); Samantha CAPORAL DEL BARRIO, Aalborg (DK)

(21) Appl. No.: 18/576,272

(22) PCT Filed: Jul. 12, 2021
(86) PCT No.: PCT/EP2021/069315

§ 371 Date: Jan. 3, 2024

(51) Int. Cl. H04B 7/06; H04L 5/16

(52) U.S. Cl. CPC H04B 7/0626; H04L 5/16

(57) ABSTRACT

The disclosure relates to an apparatus comprising at least one processor and at least one memory including computer code for one or more programs, the at least one memory and the computer code configured, with the at least one processor, to cause the apparatus at least to: determine (1000) a plurality of channel state information reference signal beams at the apparatus, wherein the plurality of channel state information reference signal beams at the apparatus have a same radiation pattern and are time division duplexed; and use (1002) the plurality of channel state information reference signal beams to send, to a repeater, a plurality of channel state information reference signals

### FIELD OF THE DISCLOSURE

The present disclosure relates to an apparatus, a method, and a computer program for communicating between a base station (e.g. gNode B) and a repeater (e.g. smart repeater).

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to an aspect there is provided an apparatus comprising means for: determining a plurality of channel state information reference signal beams at the apparatus, wherein the plurality of channel state information reference signal beams at the apparatus have a same radiation pattern and are time division duplexed; and using the plurality of channel state information reference signal beams to send, to a repeater, a plurality of channel state information reference signals.

The plurality of channel state information reference signal beams at the apparatus may have at least a same direction for a main lobe (i.e. steering lobe).

The plurality of channel state information reference signal beams at the apparatus may have a same direction or different directions for side lobes.

The plurality of channel state information reference signal beams at the apparatus may have a same gain or different gains for a main lobe (i.e. steering lobe).

The plurality of channel state information reference signal beams at the apparatus may have a same gain or different gains for side lobes.

The apparatus may comprise means for: performing a channel state information reference signal beam sweep; receive, from the repeater, channel state information reference signal measurements; and determining the plurality of channel state information reference signal beams at the apparatus based on the channel state information reference signal measurements.

A number of the plurality of channel state information reference signal beams at the apparatus may be smaller than or equal to a number of a plurality of channel state information reference signal beams at the repeater.

The apparatus may comprise means for: determining active channel state information reference signal beams at the apparatus among the plurality of channel state information reference signal beams at the apparatus, wherein active channel state information reference signal beams at the apparatus are mapped to channel state information reference signal beams at the repeater with strongest or best channel state information reference signal measurements from a user equipment, and wherein inactive channel state information reference signal beams at the apparatus are mapped to channel state information reference signal beams at the repeater with weakest or worse channel state information reference signal measurements from a user equipment.

The apparatus may comprise means for: using the active channel state information reference signal beams at the apparatus to send channel state information reference signals, control and/or data with a lower power; and using the inactive channel state information reference signal beams at the apparatus to send channel state information reference signals, control and/or data with a higher power.

The apparatus may comprise means for: receiving, from the repeater, an identifier of the repeater; and using the identifier of the repeater to send configuration information to the repeater via dedicated signalling.

The configuration information may comprise at least one of: a time division duplex frame structure; a channel state information reference signal beam identifier for each channel state information reference signal beam of the plurality of channel state information reference signal beams at the apparatus; time resources of the time division duplex frame structure allocated for each channel state information reference signal beam of the plurality of channel state information reference signal beams at the apparatus; and an active tag for each channel state information reference signal beam of the plurality of channel state information reference signal beams at the apparatus.

The apparatus may comprise means for: determining a serving synchronization signal block beam at the apparatus; and using the serving synchronization signal block beam at the apparatus to send synchronization signal blocks to the repeater.

The apparatus may comprise means for: performing a synchronization signal block beam sweep; receive, from the repeater, synchronization signal block beam measurements; and determining the serving synchronization signal block beam at the apparatus based on the synchronization signal block beam measurements.

According to an aspect there is provided an apparatus comprising at least one processor and at least one memory including computer code for one or more programs, the at least one memory and the computer code configured, with the at least one processor, to cause the apparatus at least to: determine a plurality of channel state information reference signal beams at the apparatus, wherein the plurality of channel state information reference signal beams at the apparatus have a same radiation pattern and are time division duplexed; and use the plurality of channel state information reference signal beams to send, to a repeater, a plurality of channel state information reference signals.

The plurality of channel state information reference signal beams at the apparatus may have at least a same direction for a main lobe (i.e. steering lobe).

The plurality of channel state information reference signal beams at the apparatus may have a same direction or different directions for side lobes.

The plurality of channel state information reference signal beams at the apparatus may have a same gain or different gains for a main lobe (i.e. steering lobe).

The plurality of channel state information reference signal beams at the apparatus may have a same gain or different gains for side lobes.

The at least one memory and the computer code may be configured, with the at least one processor, to cause the apparatus at least to: perform a channel state information reference signal beam sweep; receive, from the repeater, channel state information reference signal measurements; and determine the plurality of channel state information reference signal beams at the apparatus based on the channel state information reference signal measurements.

A number of the plurality of channel state information reference signal beams at the apparatus may be smaller than or equal to a number of a plurality of channel state information reference signal beams at the repeater.

The at least one memory and the computer code may be configured, with the at least one processor, to cause the apparatus at least to: determine active channel state information reference signal beams at the apparatus among the plurality of channel state information reference signal beams at the apparatus, wherein active channel state information reference signal beams at the apparatus are mapped to channel state information reference signal beams at the repeater with strongest or best channel state information reference signal measurements from a user equipment, and wherein inactive channel state information reference signal beams at the apparatus are mapped to channel state information reference signal beams at the repeater with weakest or worse channel state information reference signal measurements from a user equipment.

The at least one memory and the computer code may be configured, with the at least one processor, to cause the apparatus at least to: use the active channel state information reference signal beams at the apparatus to send channel state information reference signals, control and/or data with a lower power; and use the inactive channel state information reference signal beams at the apparatus to send channel state information reference signals, control and/or data with a higher power.

The at least one memory and the computer code may be configured, with the at least one processor, to cause the apparatus at least to: receive, from the repeater, an identifier of the repeater; and use the identifier of the repeater to send configuration information to the repeater via dedicated signalling.

The configuration information may comprise at least one of: a time division duplex frame structure; a channel state information reference signal beam identifier for each channel state information reference signal beam of the plurality of channel state information reference signal beams at the apparatus; time resources of the time division duplex frame structure allocated for each channel state information reference signal beam of the plurality of channel state information reference signal beams at the apparatus; and an active tag for each channel state information reference signal beam of the plurality of channel state information reference signal beams at the apparatus.

The at least one memory and the computer code may be configured, with the at least one processor, to cause the apparatus at least to: determine a serving synchronization signal block beam at the apparatus; and use the serving synchronization signal block beam at the apparatus to send synchronization signal blocks to the repeater.

The at least one memory and the computer code may be configured, with the at least one processor, to cause the apparatus at least to: perform a synchronization signal block beam sweep; receive, from the repeater, synchronization signal block beam measurements; and determine the serving synchronization signal block beam at the apparatus based on the synchronization signal block beam measurements.

According to an aspect there is provided an apparatus comprising circuitry configured to: determine a plurality of channel state information reference signal beams at the apparatus, wherein the plurality of channel state information reference signal beams at the apparatus have a same radiation pattern and are time division duplexed; and use the plurality of channel state information reference signal beams to send, to a repeater, a plurality of channel state information reference signals.

The plurality of channel state information reference signal beams at the apparatus may have at least a same direction for a main lobe (i.e. steering lobe).

The plurality of channel state information reference signal beams at the apparatus may have a same direction or different directions for side lobes.

The plurality of channel state information reference signal beams at the apparatus may have a same gain or different gains for a main lobe (i.e. steering lobe).

The plurality of channel state information reference signal beams at the apparatus may have a same gain or different gains for side lobes.

The circuitry may be configured to: perform a channel state information reference signal beam sweep; receive, from the repeater, channel state information reference signal measurements; and determine the plurality of channel state information reference signal beams at the apparatus based on the channel state information reference signal measurements.

A number of the plurality of channel state information reference signal beams at the apparatus may be smaller than or equal to a number of a plurality of channel state information reference signal beams at the repeater.

The circuitry may be configured to: determine active channel state information reference signal beams at the apparatus among the plurality of channel state information reference signal beams at the apparatus, wherein active channel state information reference signal beams at the apparatus are mapped to channel state information reference signal beams at the repeater with strongest or best channel state information reference signal measurements from a user equipment, and wherein inactive channel state information reference signal beams at the apparatus are mapped to channel state information reference signal beams at the repeater with weakest or worse channel state information reference signal measurements from a user equipment.

The circuitry may be configured to: use the active channel state information reference signal beams at the apparatus to send channel state information reference signals, control and/or data with a lower power; and use the inactive channel state information reference signal beams at the apparatus to send channel state information reference signals, control and/or data with a higher power.

The circuitry may be configured to: receive, from the repeater, an identifier of the repeater; and use the identifier of the repeater to send configuration information to the repeater via dedicated signalling.

The configuration information may comprise at least one of: a time division duplex frame structure; a channel state information reference signal beam identifier for each channel state information reference signal beam of the plurality of channel state information reference signal beams at the apparatus; time resources of the time division duplex frame structure allocated for each channel state information reference signal beam of the plurality of channel state information reference signal beams at the apparatus; and an active tag for each channel state information reference signal beam of the plurality of channel state information reference signal beams at the apparatus.

The circuitry may be configured to: determine a serving synchronization signal block beam at the apparatus; and use the serving synchronization signal block beam at the apparatus to send synchronization signal blocks to the repeater.

The circuitry may be configured to: perform a synchronization signal block beam sweep; receive, from the repeater, synchronization signal block beam measurements; and determine the serving synchronization signal block beam at the apparatus based on the synchronization signal block beam measurements.

According to an aspect there is provided a method comprising: determining, by a base station, a plurality of channel state information reference signal beams at the base station, wherein the plurality of channel state information reference signal beams at the base station have a same radiation pattern and are time division duplexed; and using, by the base station, the plurality of channel state information reference signal beams to send, to a repeater, a plurality of channel state information reference signals.

The plurality of channel state information reference signal beams at the base station may have at least a same direction for a main lobe (i.e. steering lobe).

The plurality of channel state information reference signal beams at the base station may have a same direction or different directions for side lobes.

The plurality of channel state information reference signal beams at the base station may have a same gain or different gains for a main lobe (i.e. steering lobe).

The plurality of channel state information reference signal beams at the base station may have a same gain or different gains for side lobes.

The method may comprise: performing a channel state information reference signal beam sweep; receive, from the repeater, channel state information reference signal measurements; and determining the plurality of channel state information reference signal beams at the base station based on the channel state information reference signal measurements.

A number of the plurality of channel state information reference signal beams at the base station may be smaller than or equal to a number of a plurality of channel state information reference signal beams at the repeater.

The method may comprise: determining active channel state information reference signal beams at the base station among the plurality of channel state information reference signal beams at the base station, wherein active channel state information reference signal beams at the base station are mapped to channel state information reference signal beams at the repeater with strongest or best channel state information reference signal measurements from a user equipment, and wherein inactive channel state information reference signal beams at the base station are mapped to channel state information reference signal beams at the repeater with weakest or worse channel state information reference signal measurements from a user equipment.

The method may comprise: using the active channel state information reference signal beams at the base station to send channel state information reference signals, control and/or data with a lower power; and using the inactive channel state information reference signal beams at the base station to send channel state information reference signals, control and/or data with a higher power.

The method may comprise: receiving, from the repeater, an identifier of the repeater; and using the identifier of the repeater to send configuration information to the repeater via dedicated signalling.

The configuration information may comprise at least one of: a time division duplex frame structure; a channel state information reference signal beam identifier for each channel state information reference signal beam of the plurality of channel state information reference signal beams at the base station; time resources of the time division duplex frame structure allocated for each channel state information reference signal beam of the plurality of channel state information reference signal beams at the base station; and an active tag for each channel state information reference signal beam of the plurality of channel state information reference signal beams at the base station.

The method may comprise: determining a serving synchronization signal block beam at the base station; and using the serving synchronization signal block beam at the base station to send synchronization signal blocks to the repeater.

The method may comprise: performing a synchronization signal block beam sweep; receive, from the repeater, synchronization signal block beam measurements; and determining the serving synchronization signal block beam at the base station based on the synchronization signal block beam measurements.

According to an aspect there is provided a computer program comprising computer executable code which when run on at least one processor is configured to: determine a plurality of channel state information reference signal beams at a base station, wherein the plurality of channel state information reference signal beams at the base station have a same radiation pattern and are time division duplexed; and use the plurality of channel state information reference signal beams to send, to a repeater, a plurality of channel state information reference signals.

The plurality of channel state information reference signal beams at the base station may have at least a same direction for a main lobe (i.e. steering lobe).

The plurality of channel state information reference signal beams at the base station may have a same direction or different directions for side lobes.

The plurality of channel state information reference signal beams at the base station may have a same gain or different gains for a main lobe (i.e. steering lobe).

The plurality of channel state information reference signal beams at the base station may have a same gain or different gains for side lobes.

The computer program may comprise computer executable code which when run on at least one processor is configured to: perform a channel state information reference signal beam sweep; receive, from the repeater, channel state information reference signal measurements; and determine the plurality of channel state information reference signal beams at the base station based on the channel state information reference signal measurements.

A number of the plurality of channel state information reference signal beams at the base station may be smaller than or equal to a number of a plurality of channel state information reference signal beams at the repeater.

The computer program may comprise computer executable code which when run on at least one processor is configured to: determine active channel state information reference signal beams at the base station among the plurality of channel state information reference signal beams at the base station, wherein active channel state information reference signal beams at the base station are mapped to channel state information reference signal beams at the repeater with strongest or best channel state information reference signal measurements from a user equipment, and wherein inactive channel state information reference signal beams at the base station are mapped to channel state information reference signal beams at the repeater with weakest or worse channel state information reference signal measurements from a user equipment.

The computer program may comprise computer executable code which when run on at least one processor is configured to: use the active channel state information reference signal beams at the base station to send channel state information reference signals, control and/or data with a lower power; and use the inactive channel state information reference signal beams at the base station to send channel state information reference signals, control and/or data with a higher power.

The computer program may comprise computer executable code which when run on at least one processor is configured to: receive, from the repeater, an identifier of the repeater; and use the identifier of the repeater to send configuration information to the repeater via dedicated signalling.

The configuration information may comprise at least one of: a time division duplex frame structure; a channel state information reference signal beam identifier for each channel state information reference signal beam of the plurality of channel state information reference signal beams at the base station; time resources of the time division duplex frame structure allocated for each channel state information reference signal beam of the plurality of channel state information reference signal beams at the base station; and an active tag for each channel state information reference signal beam of the plurality of channel state information reference signal beams at the base station.

The computer program may comprise computer executable code which when run on at least one processor is configured to: determine a serving synchronization signal block beam at the base station; and use the serving synchronization signal block beam at the base station to send synchronization signal blocks to the repeater.

The computer program may comprise computer executable code which when run on at least one processor is configured to: perform a synchronization signal block beam sweep; receive, from the repeater, synchronization signal block beam measurements; and determine the serving synchronization signal block beam at the base station based on the synchronization signal block beam measurements.

According to an aspect there is provided an apparatus comprising means for: receiving, from a base station, a plurality of channel state information reference signals sent using a plurality of channel state information reference signal beams at the base station, wherein the plurality of channel state information reference signal beams at the base station have a same radiation pattern and are time division duplexed; and using a plurality of channel state information reference signal beams at the apparatus mapped to the plurality of channel state information reference signal beams at the base station, to repeat and amplify the plurality of channel state information reference signals, wherein the plurality of channel state information reference signal beams at the apparatus have different radiation patterns.

A number of the plurality of channel state information reference signal beams at the base station may be smaller than or equal to a number of the plurality of channel state information reference signal beams at the apparatus.

The apparatus may comprise means for: receiving, from user equipment, channel state information reference signal measurements; and repeating and amplify the channel state information reference signal measurements to allow the base station to determine active channel state information reference signal beams at the base station, wherein active channel state information reference signal beams at the base station are mapped to channel state information reference signal beams at the apparatus with strongest or best channel state information reference signal measurements, and wherein inactive channel state information reference signal beams at the base station are mapped to channel state information reference signal beams at the apparatus with weakest or worse channel state information reference signal measurements.

The apparatus may comprise means for: receiving, from the base station, channel state information reference signals, control and/or data sent using active channel state information reference signal beams at the base station with a lower power; and receiving, from the base station, channel state information reference signals, control and/or data sent using inactive channel state information reference signal beams at the base station with a higher power.

The apparatus may comprise means for: sending, to the base station, an identifier of the apparatus; and receiving configuration information from the base station via dedicated signalling sent using the identifier of the apparatus.

The configuration information comprises at least one of: a time division duplex frame structure; a channel state information reference signal beam identifier for each channel state information reference signal beam of the plurality of channel state information reference signal beams at the base station; time resources of the time division duplex frame structure allocated for each channel state information reference signal beam of the plurality of channel state information reference signal beams at the base station; and an active tag for each channel state information reference signal beam of the plurality of channel state information reference signal beams at the base station.

The apparatus may comprise means for: receiving a synchronization signal block sent using a serving synchronization signal block beam at the base station; and using a synchronization signal block beam at the apparatus to repeat and amplify the synchronization signal block.

The apparatus may comprise means for: using the synchronization signal block beam at the apparatus to repeat and amplify the synchronization signal block with an omnidirectional radiation pattern.

The apparatus may comprise means for: repeating and amplifying random access channel occasions mapped to the synchronization signal block.

The apparatus may comprise means for: receiving synchronization signal blocks sent using a synchronization signal block beam sweep by the base station; using a synchronization signal block beam at the apparatus to repeat and amplify the synchronization signal blocks.

The apparatus may comprise means for: using the synchronization signal block beam at the apparatus to repeat and amplify the synchronization signal blocks with an omnidirectional radiation pattern.

The apparatus may comprise means for: repeating and amplifying all random access channel occasions mapped to all synchronization signal blocks.

According to an aspect there is provided an apparatus comprising at least one processor and at least one memory including computer code for one or more programs, the at least one memory and the computer code configured, with the at least one processor, to cause the apparatus at least to: receive, from a base station, a plurality of channel state information reference signals sent using a plurality of channel state information reference signal beams at the base station, wherein the plurality of channel state information reference signal beams at the base station have a same radiation pattern and are time division duplexed; and use a plurality of channel state information reference signal beams at the apparatus mapped to the plurality of channel state information reference signal beams at the base station, to repeat and amplify the plurality of channel state information reference signals, wherein the plurality of channel state information reference signal beams at the apparatus have different radiation patterns.

A number of the plurality of channel state information reference signal beams at the base station may be smaller than or equal to a number of the plurality of channel state information reference signal beams at the apparatus.

The at least one memory and the computer code may be configured, with the at least one processor, to cause the apparatus at least to: receive, from user equipment, channel state information reference signal measurements; and repeat and amplify the channel state information reference signal measurements to allow the base station to determine active channel state information reference signal beams at the base station, wherein active channel state information reference signal beams at the base station are mapped to channel state information reference signal beams at the apparatus with strongest or best channel state information reference signal measurements, and wherein inactive channel state information reference signal beams at the base station are mapped to channel state information reference signal beams at the apparatus with weakest or worse channel state information reference signal measurements.

The at least one memory and the computer code may be configured, with the at least one processor, to cause the apparatus at least to: receive, from the base station, channel state information reference signals, control and/or data sent using active channel state information reference signal beams at the base station with a lower power; and receive, from the base station, channel state information reference signals, control and/or data sent using inactive channel state information reference signal beams at the base station with a higher power.

The at least one memory and the computer code may be configured, with the at least one processor, to cause the apparatus at least to: send, to the base station, an identifier of the apparatus; and receive configuration information from the base station via dedicated signalling sent using the identifier of the apparatus.

The configuration information comprises at least one of: a time division duplex frame structure; a channel state information reference signal beam identifier for each channel state information reference signal beam of the plurality of channel state information reference signal beams at the base station; time resources of the time division duplex frame structure allocated for each channel state information reference signal beam of the plurality of channel state information reference signal beams at the base station; and an active tag for each channel state information reference signal beam of the plurality of channel state information reference signal beams at the base station.

The at least one memory and the computer code may be configured, with the at least one processor, to cause the apparatus at least to: receive a synchronization signal block sent using a serving synchronization signal block beam at the base station; and use a synchronization signal block beam at the apparatus to repeat and amplify the synchronization signal block.

The at least one memory and the computer code may be configured, with the at least one processor, to cause the apparatus at least to: use the synchronization signal block beam at the apparatus to repeat and amplify the synchronization signal block with an omnidirectional radiation pattern.

The at least one memory and the computer code may be configured, with the at least one processor, to cause the apparatus at least to: repeat and amplify random access channel occasions mapped to the synchronization signal block.

The at least one memory and the computer code are configured, with the at least one processor, to cause the apparatus at least to: receive synchronization signal blocks sent using a synchronization signal block beam sweep by the base station; use a synchronization signal block beam at the apparatus to repeat and amplify the synchronization signal blocks.

The at least one memory and the computer code are configured, with the at least one processor, to cause the apparatus at least to: use the synchronization signal block beam at the apparatus to repeat and amplify the synchronization signal blocks with an omnidirectional radiation pattern.

The at least one memory and the computer code are configured, with the at least one processor, to cause the apparatus at least to: repeat and amplify all random access channel occasions mapped to all synchronization signal blocks.

According to an aspect there is provided an apparatus comprising circuitry configured to: receive, from a base station, a plurality of channel state information reference signals sent using a plurality of channel state information reference signal beams at the base station, wherein the plurality of channel state information reference signal beams at the base station have a same radiation pattern and are time division duplexed; and use a plurality of channel state information reference signal beams at the apparatus mapped to the plurality of channel state information reference signal beams at the base station, to repeat and amplify the plurality of channel state information reference signals, wherein the plurality of channel state information reference signal beams at the apparatus have different radiation patterns.

A number of the plurality of channel state information reference signal beams at the base station may be smaller than or equal to a number of the plurality of channel state information reference signal beams at the apparatus.

The circuitry may be configured to: receive, from user equipment, channel state information reference signal measurements; and repeat and amplify the channel state information reference signal measurements to allow the base station to determine active channel state information reference signal beams at the base station, wherein active channel state information reference signal beams at the base station are mapped to channel state information reference signal beams at the apparatus with strongest or best channel state information reference signal measurements, and wherein inactive channel state information reference signal beams at the base station are mapped to channel state information reference signal beams at the apparatus with weakest or worse channel state information reference signal measurements.

The circuitry may be configured to: receive, from the base station, channel state information reference signals, control and/or data sent using active channel state information reference signal beams at the base station with a lower power; and receive, from the base station, channel state information reference signals, control and/or data sent using inactive channel state information reference signal beams at the base station with a higher power.

The circuitry may be configured to: send, to the base station, an identifier of the apparatus; and receive configuration information from the base station via dedicated signalling sent using the identifier of the apparatus.

The configuration information comprises at least one of: a time division duplex frame structure; a channel state information reference signal beam identifier for each channel state information reference signal beam of the plurality of channel state information reference signal beams at the base station; time resources of the time division duplex frame structure allocated for each channel state information reference signal beam of the plurality of channel state information reference signal beams at the base station; and an active tag for each channel state information reference signal beam of the plurality of channel state information reference signal beams at the base station.

The circuitry may be configured to: receive a synchronization signal block sent using a serving synchronization signal block beam at the base station; and use a synchronization signal block beam at the apparatus to repeat and amplify the synchronization signal block.

The circuitry may be configured to: use the synchronization signal block beam at the apparatus to repeat and amplify the synchronization signal block with an omnidirectional radiation pattern.

The circuitry may be configured to: repeat and amplify random access channel occasions mapped to the synchronization signal block.

The circuitry may be configured to: receive synchronization signal blocks sent using a synchronization signal block beam sweep by the base station; use a synchronization signal block beam at the apparatus to repeat and amplify the synchronization signal blocks.

The circuitry may be configured to: use the synchronization signal block beam at the apparatus to repeat and amplify the synchronization signal blocks with an omnidirectional radiation pattern.

The circuitry may be configured to: repeat and amplify all random access channel occasions mapped to all synchronization signal blocks.

According to an aspect there is provided a method comprising: receiving, by a repeater from a base station, a plurality of channel state information reference signals sent using a plurality of channel state information reference signal beams at the base station, wherein the plurality of channel state information reference signal beams at the base station have a same radiation pattern and are time division duplexed; and using, by the repeater, a plurality of channel state information reference signal beams at the repeater mapped to the plurality of channel state information reference signal beams at the base station, to repeat and amplify the plurality of channel state information reference signals, wherein the plurality of channel state information reference signal beams at the repeater have different radiation patterns.

A number of the plurality of channel state information reference signal beams at the base station may be smaller than or equal to a number of the plurality of channel state information reference signal beams at the repeater.

The method may comprise: receiving, by the repeater from user equipment, channel state information reference signal measurements; and repeating and amplify, by the repeater, the channel state information reference signal measurements to allow the base station to determine active channel state information reference signal beams at the base station, wherein active channel state information reference signal beams at the base station are mapped to channel state information reference signal beams at the repeater with strongest or best channel state information reference signal measurements, and wherein inactive channel state information reference signal beams at the base station are mapped to channel state information reference signal beams at the repeater with weakest or worse channel state information reference signal measurements.

The method may comprise: receiving, by the repeater from the base station, channel state information reference signals, control and/or data sent using active channel state information reference signal beams at the base station with a lower power; and receiving, by the repeater from the base station, channel state information reference signals, control and/or data sent using inactive channel state information reference signal beams at the base station with a higher power.

The method may comprise: sending, by the repeater to the base station, an identifier of the repeater; and receiving configuration information from the base station via dedicated signalling sent using the identifier of the repeater.

The configuration information comprises at least one of: a time division duplex frame structure; a channel state information reference signal beam identifier for each channel state information reference signal beam of the plurality of channel state information reference signal beams at the base station; time resources of the time division duplex frame structure allocated for each channel state information reference signal beam of the plurality of channel state information reference signal beams at the base station; and an active tag for each channel state information reference signal beam of the plurality of channel state information reference signal beams at the base station.

The method may comprise: receiving, by the repeater, a synchronization signal block sent using a serving synchronization signal block beam at the base station; and using a synchronization signal block beam at the repeater to repeat and amplify the synchronization signal block.

The method may comprise: using, by the repeater, the synchronization signal block beam at the repeater to repeat and amplify the synchronization signal block with an omnidirectional radiation pattern.

The method may comprise: repeating and amplifying, by the repeater, random access channel occasions mapped to the synchronization signal block.

The method may comprise: receiving, by the repeater, synchronization signal blocks sent using a synchronization signal block beam sweep by the base station; using a synchronization signal block beam at the repeater to repeat and amplify the synchronization signal blocks.

The method may comprise: using, by the repeater, the synchronization signal block beam at the repeater to repeat and amplify the synchronization signal blocks with an omnidirectional radiation pattern.

The method may comprise: repeating and amplifying, by the repeater, all random access channel occasions mapped to all synchronization signal blocks.

According to an aspect there is provided a computer program comprising computer executable code which when run on at least one processor is configured to receive, by a repeater from a base station, a plurality of channel state information reference signals sent using a plurality of channel state information reference signal beams at the base station, wherein the plurality of channel state information reference signal beams at the base station have a same radiation pattern and are time division duplexed; and use, by the repeater, a plurality of channel state information reference signal beams at the repeater mapped to the plurality of channel state information reference signal beams at the base station, to repeat and amplify the plurality of channel state information reference signals, wherein the plurality of channel state information reference signal beams at the repeater have different radiation patterns.

A number of the plurality of channel state information reference signal beams at the base station may be smaller than or equal to a number of the plurality of channel state information reference signal beams at the repeater.

The computer program may comprise computer executable code which when run on at least one processor is configured to: receive, by the repeater from user equipment, channel state information reference signal measurements; and repeat and amplify the channel state information reference signal measurements to allow the base station to determine active channel state information reference signal beams at the base station, wherein active channel state information reference signal beams at the base station are mapped to channel state information reference signal beams at the repeater with strongest or best channel state information reference signal measurements, and wherein inactive channel state information reference signal beams at the base station are mapped to channel state information reference signal beams at the repeater with weakest or worse channel state information reference signal measurements.

The computer program may comprise computer executable code which when run on at least one processor is configured to: receive, by the repeater from the base station, channel state information reference signals, control and/or data sent using active channel state information reference signal beams at the base station with a lower power; and receive, by the repeater from the base station, channel state information reference signals, control and/or data sent using inactive channel state information reference signal beams at the base station with a higher power.

The computer program may comprise computer executable code which when run on at least one processor is configured to: send, by the repeater to the base station, an identifier of the repeater; and receive configuration information from the base station via dedicated signalling sent using the identifier of the repeater.

The configuration information comprises at least one of: a time division duplex frame structure; a channel state information reference signal beam identifier for each channel state information reference signal beam of the plurality of channel state information reference signal beams at the base station; time resources of the time division duplex frame structure allocated for each channel state information reference signal beam of the plurality of channel state information reference signal beams at the base station; and an active tag for each channel state information reference signal beam of the plurality of channel state information reference signal beams at the base station.

The computer program may comprise computer executable code which when run on at least one processor is configured to: receive, by the repeater, a synchronization signal block sent using a serving synchronization signal block beam at the base station; and use, by the repeater, a synchronization signal block beam at the repeater to repeat and amplify the synchronization signal block.

The computer program may comprise computer executable code which when run on at least one processor is configured to: use, by the repeater, the synchronization signal block beam at the apparatus to repeat and amplify the synchronization signal block with an omnidirectional radiation pattern.

The computer program may comprise computer executable code which when run on at least one processor is configured to: repeat and amplify, by the repeater, random access channel occasions mapped to the synchronization signal block.

The computer program may comprise computer executable code which when run on at least one processor is configured to: receive, by the repeater, synchronization signal blocks sent using a synchronization signal block beam sweep by the base station; use, by the repeater, a synchronization signal block beam at the apparatus to repeat and amplify the synchronization signal blocks.

The computer program may comprise computer executable code which when run on at least one processor is configured to: use, by the repeater, the synchronization signal block beam at the apparatus to repeat and amplify the synchronization signal blocks with an omnidirectional radiation pattern.

The computer program may comprise computer executable code which when run on at least one processor is configured to: repeat and amplify, by the repeater, all random access channel occasions mapped to all synchronization signal blocks.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### List of Abbreviations

AF Application Function
AMF: Access and Mobility Management Function
API: Application Protocol Interface
BS: Base Station
CSI-RS: Channel State Information Reference Signal
CU: Centralized Unit
DL: Downlink
DU: Distributed Unit
gNB: gNodeB
GSM: Global System for Mobile communication
HSS: Home Subscriber Server
ID: Identifier
IoT: Internet of Things
LTE: Long Term Evolution
MAC: Medium Access Control
MS: Mobile Station
MTC: Machine Type Communication
NEF: Network Exposure Function
NF: Network Function
NR: New radio
NRF: Network function Repository Function
PDU: Packet Data Unit
OFDM: Orthogonal Frequency Division Multiplexing
PDCCH: Physical Downlink Control Channel
PDSCH: Physical Downlink Shared Channel
PRB: Physical Resource Block
PUCCH: Physical Uplink Control Channel
RACH: Random Access Channel
RAM: Random Access Memory
(R)AN: (Radio) Access Network
RF: Radio Frequency
ROM: Read Only Memory
RSRP: Reference Signal Received Power
RSRQ: Reference Signal Received Quality
SMF: Session Management Function
SR: Smart Repeater
SSB: Synchronization Signal Block
TDD: Time Division Duplexed
TR: Technical Report
TS Technical Specification
UCI: Uplink Control Information
UE: User Equipment
UMTS: Universal Mobile Telecommunication System
3GPP: 3^{rd} Generation Partnership Project
5G: 5^{th} Generation
5GC: 5G Core network
5GS: 5G System

### BRIEF DESCRIPTION OF THE FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a schematic representation of a dedicated signalling for a smart repeater from a gNodeB to the smart repeater in contrast to pass-through signal from the gNodeB to user equipment;

FIG. 5 shows a schematic representation of a high level architecture block diagram of a smart repeater;

FIG. 6 shows the problem of beam management between a smart repeater and user equipment;

FIG. 7 the problem of co-channel interference increase on neighboring cells due to signal amplification from a smart repeater;

FIG. 8 shows a CSI-RS beam based solution for a smart repeater beam control, wherein CSI-RS are sent over CSI-RS beams BN until BN+m at the gNodeB to smart repeater side with a same radiation pattern and are repeated and amplified over CSI-RS beams BN until BN+m at the smart repeater to user equipment side with different radiation patterns;

FIG. 9 shows of a signalling diagram of a process for using a plurality of channel state information reference signal beams to send, by a gNodeB to a smart repeater, a plurality of channel state information reference signals;

FIG. 10 shows a block diagram of a method for using a plurality of channel state information reference signal beams to send, by a gNodeB to a smart repeater, a plurality of channel state information reference signals;

FIG. 11 shows a block diagram of a method for receiving, by a smart repeater, a plurality of channel state information reference signals sent, by a gNodeB, using a plurality of channel state information reference signal beams; and

FIG. 12 shows a schematic representation of a non-volatile memory medium storing instructions which when executed by a processor allow a processor to perform one or more of the steps of the methods of FIGS. 10 and 11.

### DETAILED DESCRIPTION OF THE FIGURES

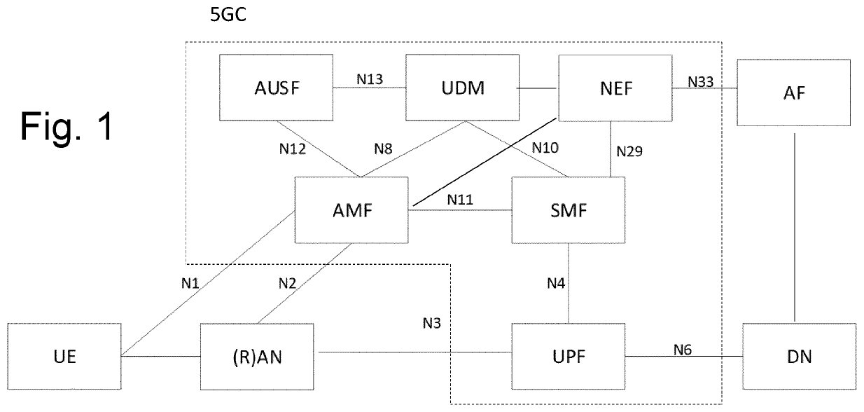

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may comprises a terminal, a (radio) access network ((R)AN), a 5G core network (5GC), one or more application functions (AF) and one or more data networks (DN).

The 5G (R)AN may comprise one or more gNodeB (gNB) distributed unit functions connected to one or more gNodeB (gNB) centralized unit functions. The 5G (R)AN may comprise one or more smart repeaters (SR).

The 5GC may comprise an access and mobility management function (AMF), a session management function (SMF), an authentication server function (AUSF), a user data management (UDM), a user plane function (UPF) and/or a network exposure function (NEF).

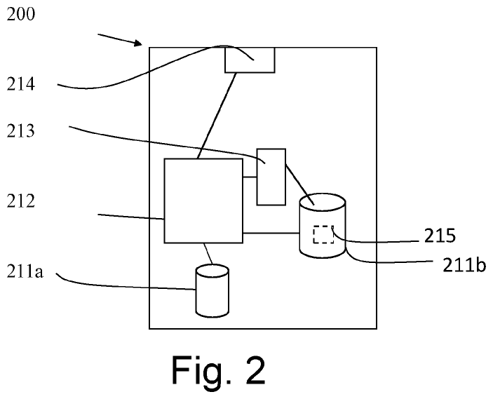

FIG. 2 illustrates an example of a control apparatus 200 for controlling a function of the (R)AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G (R)AN or the 5GC. In some embodiments, each function of the (R)AN or the 5GC comprises a control apparatus 200. In alternative embodiments, two or more functions of the (R)AN or the 5GC may share a control apparatus.

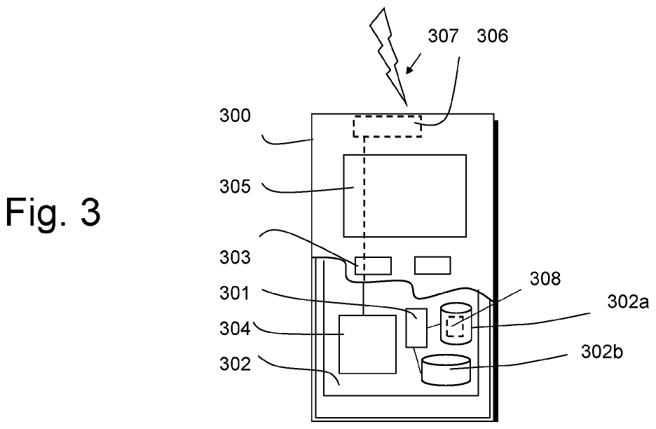

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

Email discussion for RAN4 R17 non-spectrum work areas: Smart Repeaters (RP-201830) reads as follows:

“Coverage is a fundamental aspect of cellular network deployments. Mobile operators resort to different types of network nodes to offer blanket coverage in their deployments. While the deployment of regular full-stack cells is preferred, it may not be always possible (e.g., no availability of backhaul) or economically viable option. As a result, new types of network nodes have been considered to increase mobile operators' flexibility for their network deployments. NR Rel-16 has introduced a new type of network node not requiring a wired backhaul through the specification of Integrated Access and Backhaul (IAB). The IAB node is a new type of relay node building over the front-haul architecture and constituting a node with a dual personality consisting of a Distributed Unit (DU) component making it possible to appear as a regular cell to the UEs it serves, and as a Mobile Terminal (MT) component inheriting many properties of a regular UE which connects to its donor parent node(s). The IAB node is based on a Layer 2 architecture with end-to-end PDCP layer from the donor IAB node to the UE for Control Plane (CP) and User Plane (UP). IAB nodes can also be classified as re-generative relays, as every packet traversing the link between its donor and the MT component of the IAB node itself, i.e., backhaul-link, has to be properly decoded and re-encoded by the IAB node for transmission to the UE or subsequent IAB hop on the access link. While the first version of IAB in Rel-16 assumes half duplex operation between access and backhaul for transmission and reception, forward compatibility towards evolving IAB towards full duplex operation was put in place. One of the objectives of the Rel-17 IAB WI is to, indeed, enable full duplex implementations of IAB nodes.

Another type of network node is the RF repeater. RF repeaters have been used in 2G, 3G and 4G deployments to supplement the coverage provided by regular full-stack cells with various transmission power characteristics. They constitute the simplest and most cost-effective way to improve network coverage. The main advantages of RF repeaters are their low-cost, their ease of deployment and the fact that they do not increase latency. The main disadvantage is that they amplify all received signals plus noise and, hence, may contribute to an increase of interference (pollution) in the system. Within RF repeaters, there are different categories depending on the power characteristics and the amount of spectrum that they are configured to amplify (e.g., single band, multi-band, etc.). RF repeaters are non-regenerative type of relay nodes and they simply amplify-and-forward everything that they receive. RF repeaters are typically full-duplex nodes and they do not differentiate between UL and DL from transmission or reception standpoint. Note that, to date, there is no definition of RF repeaters for NR.

As NR moves to higher frequencies (around 4 GHz for FR1 deployments and above 24 GHz for FR2) propagation conditions degrade compared to lower frequencies exacerbating the coverage challenges. As a result, further densification of cells may be necessary. Multi-antenna techniques consisting of massive MIMO for FR1 and analog beamforming for FR2 assist in coping with the more challenging propagation conditions of these higher frequencies.

Note that all the frequency bands defined at this higher frequency regime are TDD.

Another common property of these NR systems is the use of multi-beam operation with associated beam management in FR2”.

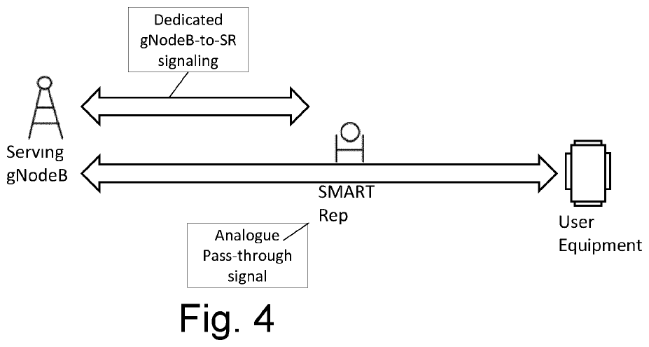

One or more aspects of this disclosure relate to a type of repeater designated as smart repeater (SR) for mmWave part of the 3GPP NR standard. Smart repeaters have a dedicated signalling from gNodeB to SR while letting signal from gNodeB to UE be amplified without any digital modifications affecting the control or data information included in the signal. Such type of repeater is illustrated in FIG. 4.

A goal of the SR is to outperform the legacy RF repeater that simply amplifies signal the SR receives in a full duplex manner irrespective of whether the signal is desired or not. Thus, a goal of the SR is to amplify parts of the signal that are useful for the UEs the SR serves. In this way, the interference pollution in the network may be minimized. A SR may be beamformed in the direction of the UE and the beams directed towards the UE may be amplified.

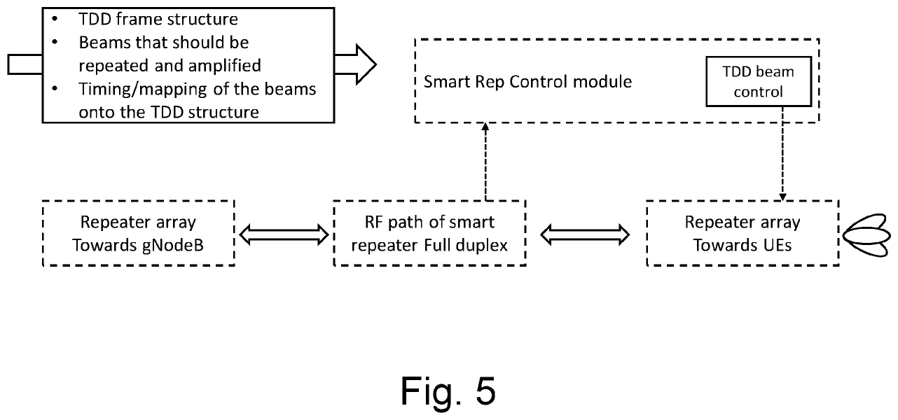

A high level SR architecture block diagram is depicted in FIG. 5. The SR may comprise an antenna array on the SR to gNodeB side and another antenna array on the SR to UE side. The SR may comprise a RF path configured to amplify signal the SR receives in a full duplex manner. The SR may comprise a SR control module configured to decode the dedicated signalling between a gNB and the SR and based to adjust analogue beams at the other antenna array on the SR to UE side based on the dedicated signalling.

The dedicated signalling between the gNB and the SR comprise configuration information. The configuration information may include a time division duplexed (TDD) frame structure for one or more analogue beams at the antenna array on the SR to gNodeB side, beam identifiers (IDs) for one or more analogue beams at the antenna array on the SR to gNodeB side and/or time resources of the TDD frame structure allocated for one or more analogue beams at the antenna array on the SR to gNodeB side.

Moderator's summary for email discussion [90E][47][RAN4_repeater] (RP-202889) reads as follows:

“Supported by Qualcomm, Commscope, MediaTek Inc., Verizon Wireless, CMCC, Telstra, Telecom Italia, Deutsche Telekom, Orange, Charter Communications Inc, T-Mobile USA, KT Corp., AT&T, British Telecom, China Telecom, KDDI, CableLabs, CHTTL proposes the following Objectives for the Rel-17 WI on NR Repeaters: Normative work phase objective [RAN4]
Specify RF and EMC requirements for NR repeaters
Consider FR1 (FDD and TDD) and FR2 (TDD) bands
   Study phase objective [RAN4]
Assess the coverage/performance advantages of smart repeaters over RF repeaters offered by having side control information to selectively apply amplify-and-forward relay operation assuming availability of the following [RAN4]:
   Timing information, i.e., slot and symbol UL/DL configuration
   Transmitter and receiver spatial information, i.e., beam information
Checkpoint at RAN #93 to task RAN1 and RAN2 as necessary to determine the specification impact and assess complexity level versus IAB to support smart repeaters and decision on how to proceed with normative work

For all of the above objectives, the leveraging of RF specifications for LTE repeater and IAB should be sought while targeting a substantial simplification of the overall specification and associated cost and implementation”.

In the context of 3GPP NR FR2 and beyond, we assume usage of analogue beams per gNB panel. Thus, we may assume a single analogue beam per gNB panel per OFDM symbol granularity.

As depicted in FIG. 4 a SR may require dedicated signalling between the gNB and the SR. The dedicated signalling is not defined in 3GPP yet and leads to many open questions and problems to be solved.

One or more aspects of this disclosure relate to the problem of beam management between the SR and the UE.

One or more aspects of this disclosure relate to the problem of co-channel interference increase on neighboring cells due to signal amplification from the SR.

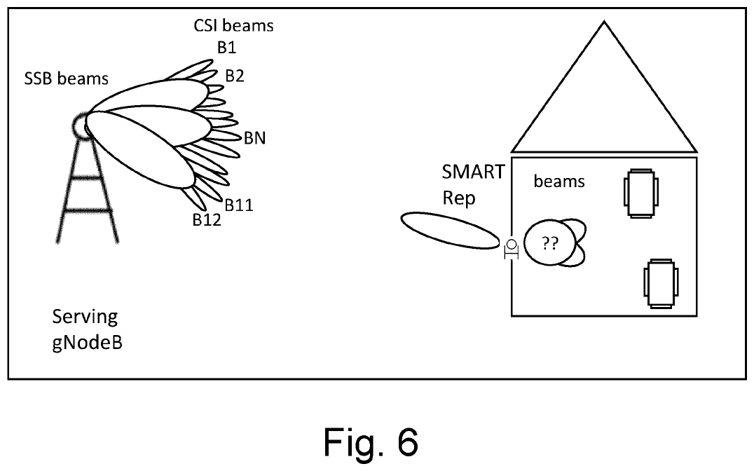

An example of the problem of beam management between the SR and the UE is illustrated in FIG. 6. A gNB may be configured with broad synchronization signal block (SSB) beams and narrow channel state information reference signal (CSI-RS) beams. A SR may be placed on a building wall where it helps reducing high mmWave building penetration loss. The SR may be static. In such context different issues may arise. How should the SR manage CSI-RS beams between the SR and the UE? How should the signalling flow work between the gNB and the SR.

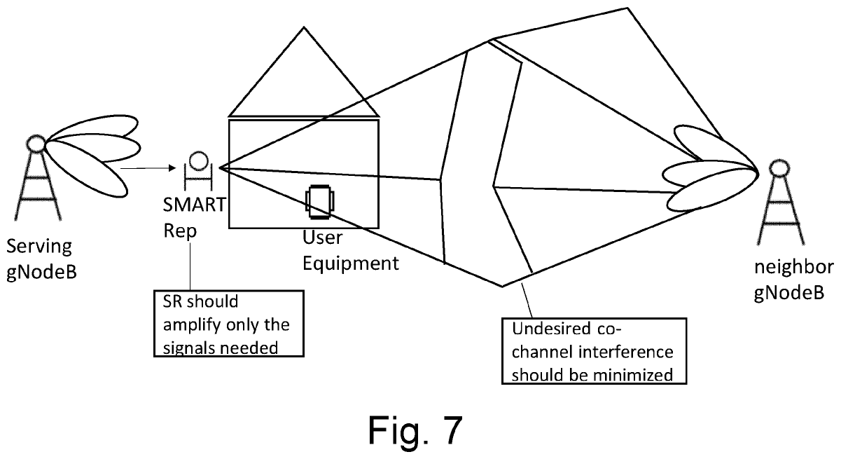

An example of the problem of co-channel interference increase on neighboring cells due to signal amplification from the SR is illustrated in FIG. 7. Some of the signals originating from the gNB may be repeated and amplified beyond normal cell coverage of the gNB and may create interference in the cell coverage of a neighbor gNB. In such context an issue may arise. How could the SR minimize interference in the cell coverage of the neighbor gNB?

Interference in the cell coverage of a neighbor gNB may be caused by signals which are not intended for the UE served by the SR in the downlink. These signals should not be repeated, amplified and beamformed by the SR. These signals may comprise physical downlink shared channel (PDSCH) data physical resource blocks (PRB), physical downlink control channel (PDSCH) control physical resource blocks (PRB), orthogonal frequency division multiplexing (OFDM) symbols with SSBs and/or OFDM symbols with CSI-RS.

Reconfigurable Intelligent Surfaces for Wireless Communications: Principles, Challenges, and Opportunities IEEE Transactions on Cognitiv >Volume: 6 Issue: 3 (Mohamed A. ElMossallamy; Hongliang Zhang; Lingyang Song; Karim G. Seddik; Zhu Han; Geoffrey Ye Li) describe programmable surfaces. These programmable surfaces are currently X-factor times more expensive and complex to manage than a SR.

CHARTING THE FUTURE OF INNOVATION|#07•2020, Ericcsson Technology Review, Introducing Integrated Access Backhaul relate to IAB. The main drawback of IAB is that it relies on the fully decoded transmitted data and reencoding it for relaying. This means a cost in latency of signal, architecture pricing and signalling complexity compared to smart repeaters.

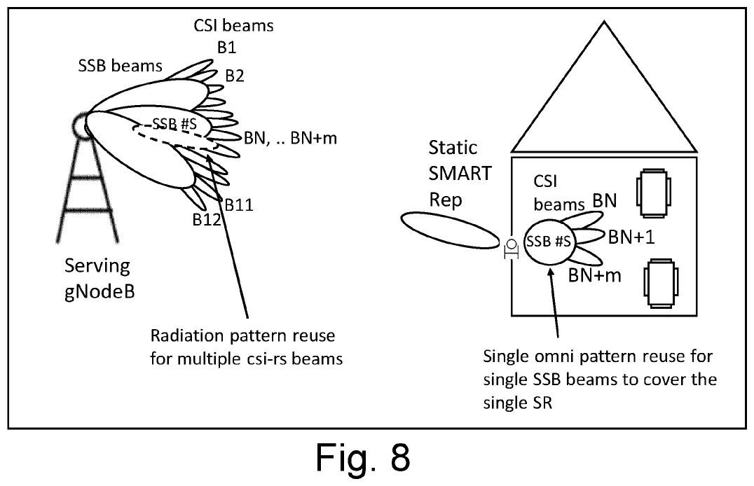

FIG. 8 shows a CSI-RS beam based solution for a smart repeater beam control. CSI-RS may be sent over CSI-RS beams BN until BN+m at the gNB to SR side with a same radiation pattern and may be repeated and amplified over CSI-RS beams BN until BN+m at the SR to UE side with different radiation patterns.

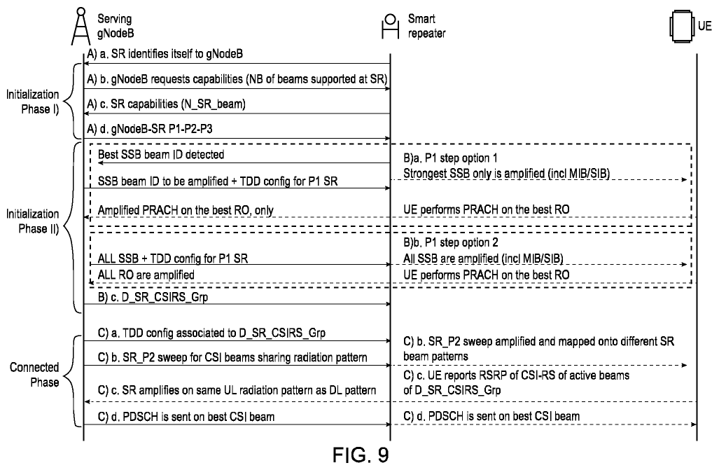

FIG. 9 shows of a signalling diagram of a process for using a plurality of CSI-RS beams to send, by a gNB to a SR, a plurality of CSI-RS.

A) Initialization Phase I): gNodeB to SR

In step A).a a gNB may identify a SR. An identifier of the SR may be part of UE capability information.

In step A).b the gNB may send a request to the SR for a number N_SR of beams supported by the SR on the SR-to-UE side. The request may be sent via a dedicated fronthaul link between gNB and SR with a control path containing UL/DL signals to configure the SR.

In step A).c the gNB may receive a response from the SR with the number N_SR of beams supported by the SR on the SR-to-UE side.

In step A)d. the gNB and the SR perform beam alignment.

The 5G New Radio (NR) Release 15 gNB<->UE beam alignment procedure is described in 3GPP TR 38.802 section 6.1.6 and in TS 38.214 section 5.2. The beam alignment procedure includes 3 main phases as described below with reference to FIG. 1.

Phase #1: UE is configured for broad beam RX while gNB is performing DL SSB beam sweeping. UE measures RSRP for all SSB beams received and reports back to the gNB using same beam configuration as in RX, at the next time instance (RACH Group) which corresponds to the information decoded (MIB, SIB1 & SIB2) from the best SSB beam seen from the UE.

Phase #2: UE is configured for broad beam RX while gNB is performing refined DL CSI-RS beam sweeping. UE measures RSRP (or CQI & RI) for all CSI-RS or SSB beams received and reports best beam ID back to gNB using same beam configuration as in RX.

Phase #3: gNB transmits with best beam found in Phase #2 and UE is sweeping refined RX beam settings for identification of the best narrow RX beam.

At the end of P3 alignment between gNB TX beam and UE RX beam is obtained for maximized directional gain and minimum interference to other users in serving and neighbor cells.

For example, the gNB may perform a SSB beam sweep. The SR may measure SSBs for the SSB beams. The SR may report a strongest or best SSB measurement to the gNB The SSB measurement may comprise reference signal received power (RSRP) measurement, reference signal received quality (RSRQ) measurement or the like. The gNB may set a serving SSB beam as the SSB beam of the SSB beam sweep with the strongest or best SSB measurement.

Likewise, the gNB may perform a CSI-RS beam sweep. The SR may measure CSI-RSs for the CSI-RS beams. The SR may report a strongest or best CSI-RS measurement to the gNB. The CSI-RS measurement may comprise RSRP measurement, RSRQ measurement or the like. The gNB may set a serving CSI-RS beam as the CSI-RS beam of the CSI-RS beam sweep with the strongest or best CSI-RS measurement.

### B) Initialization Phase II): SR to UE

In step B).a P1 step option 1, the gNB may perform a SSB beam sweep. The SR may measure SSBs for the SSB beams. The SR may report a strongest or best SSB measurement to the gNB The gNB may set a serving SSB beam as the SSB beam of the SSB beam sweep with the strongest or best SSB measurement.

It will be understood that the result of the SSB beam sweep discussed above may be reused an another SSB beam sweep may not be performed. It will be also understood that the result of another SSB beam sweep may be used and another SSB beam sweep may be performed.

Alternatively, the SR may measure SSBs for the SSB beams. The SR may report N strongest or best SSB measurements to the gNB. The gNB may set N serving SSB beams as the N SSB beams of the SSB beam sweep with the N strongest or best SSB measurements. N may be an integer greater than 1.

In the following, the scenario where the gNB has set a single serving SSB beam is discussed. The scenario where the gNB has set N serving SSB beams is not discussed for the sake of conciseness but contemplated by this disclosure.

The gNB may determine random access channel (RACH) occasions mapped to the serving SSB beam. The gNB may send an indication of the RACH occasions to the SR. Alternatively, the SR may autonomously determine RACH occasions mapped to the serving SSB beam.

The gNB may send configuration information to the SR via dedicated signalling. The configuration information may comprise a SSB beam identifier of the serving SSB beam, the TDD frame structure (time slot and/or symbol structure) of the serving SSB beam and/or the time resources (uplink and/or downlink time resources) of the TDD frame structure allocated to the serving SSB beam.

The SR may repeat and amplify the SSBs sent by the gNB on the serving SSB beam on the SR to UE side with an omnidirectional radiation pattern.

The SR may repeat and amplify the RACH preambles sent by the UE on the RACH occasions mapped to the serving SSB beam.

In step B).b P1 step option 2, the SR may operate as a RF repeater. The SR may repeat and amplify all SSBs sent on all SSB beams by the gNB on the SR to UE side with an omnidirectional radiation pattern.

The SR may repeat and amplify all RACH preambles sent by the UE on all RACH occasions mapped to all SSB beams on the SR to gNB side.

In step B).c the gNB may determine (i.e. allocate) a number N_SR_CSI-RS of CSI-RS beams. The number N_SR_CSI-RS of CSI-RS beams may be lower than or equal to number N_SR of beams supported by the SR on the SR to UE side.

These CSI-RS beams may form a SR CSI beam group (D_SR_CSIRS_Grp) specific to the SR. These CSI-RS beams may share a same radiation pattern on the gNB to SR side since they all serve the specific SR. These CSI-RS beams may be allocated different time resources of the TDD frame structure.

The serving CSI-RS beam determined in step A).d. and the CSI-RS beams of the D_SR_CSIRS_Grp may share a same radiation pattern on the gNB to SR side.

The gNodeB may send configuration information to the SR via dedicated signalling. The configuration information may comprise CSI-RS beam identifiers of these CSI-RS beams, the TDD frame structure (time slot and/or symbol structure) of these CSI-RS beams and/or the time resources (uplink and/or downlink time resources) of the TDD frame structure allocated to the CSI-RS beams.

### C) Connected Phase

In step C).a the gNB may continuously or periodically send configuration information to the SR via dedicated signalling. The configuration information may comprise SSB beam identifiers of the serving SSB beam, the TDD frame structure of the serving SSB beam and/or the time resources of the TDD frame structure allocated to the serving SSB beam with.

The gNB may send continuously or periodically send configuration information to the SR via dedicated signalling. The configuration information may comprise CSI-RS beam identifiers of the CSI-RS beams of the D_SR_CSIRS_Grp, the TDD frame structure of these CSI-RS beams and/or the time resources of the TDD frame structure allocated to the CSI-RS beams to.

In step C).b the gNB may send a burst of CSI-RS over the CSI-RS beams of the D_SR_CSIRS_Grp on the gNB to SR side with a same radiation pattern. The SR may repeat and amplify the CSI-RS over CSI-RS beams on the SR to UE side with different radiation patterns. The CSI-RS beams of the D_SR_CSIRS_Grp on the gNB to SR side are mapped to the CSI-RS beams on the SR to UE side.

In step C).c the SR may receive CSI-RS measurements from the UE over the CSI-RS beams on the SR to UE side with different radiation patterns. The CSI-RS measurements may be received in a physical uplink control channel (PUCCH) for example in uplink control information (UCI) on time resources of the TDD frame structure.

The SR may repeat and amplify the CSI-RS measurements received over the CSI-RS beams of the D_SR_CSIRS_Grp on the gNB to SR side with a same radiation pattern.

The gNB may determine active CSI-RS beams based on the CSI-RS measurements from the UE. The active CSI-RS beams are mapped to CSI-RS beams at the SR with the strongest CSI-RS measurements from the UE and therefore serving the UE. The inactive CSI-RS beams are mapped to CSI-RS beams at the SR with the weakest CSI-RS measurements from the UE and therefore not serving the UE.

The gNB may continuously or periodically send CSI-RS, control and/or data over the active CSI-RS beams on the gNB to SR side with a same radiation pattern. For example, the gNB may continuously or periodically send data over a PDSCH of the active CSI-RS beams on the gNB to SR side with a same radiation pattern.

The SR may decode the configuration information in the dedicated signalling to properly repeat and amplify the CSI-RS, control and/or data on the SR to UE side over CSI-RS beams with different radiation patterns.

The gNB may continuously or periodically send SSB over the serving SSB beam on the gNB to SR side.

The SR may decode the configuration information in the dedicated signalling to properly repeat and amplify the SSB on the SR to UE side over an SSB beam with an omnidirectional radiation pattern.

In order to minimize interference in the cell coverage area of a neighbour gNB the SR may repeat and amplify on the SR to UE side the SSB sent by the gNB over the serving SSB beam on the gNB to SR side and the CSI-RS, control and/or data sent by the gNB over the active CSI-RS beams on the SR to UE side.

In order to allow the SR to distinguish between active CSI-RS beams and inactive CSI-RS beams several way may be considered.

In an example, the gNB may use the active CSI-RS beams to send CSI-RS, control and/or data with a lower power. By contrast, the gNB may use the inactive CSI-RS beam to send CSI-RS, control and/or data with a lower power. In this way, the SR may distinguish between active CSI-RS beams on the gNB to SR side mapped to CSI-RS on the SR to UE side serving UE and inactive CSI-RS beams on the gNB to SR side mapped to CSI-RS on the SR to UE side not serving UE.

In another example, the gNB may send further configuration information to the SR via dedicated signaling. The further configuration information may comprise an active tag (or UE tag) for the active CSI-RS in addition to the CSI-RS beam identifiers of the CSI-RS beams of the D_SR_CSIRS_Grp, the TDD frame structure of the CSI-RS beams of the D_SR_CSIRS_Grp and/or the time resources of the TDD frame structure allocated to the CSI-RS beams of the D_SR_CSIRS_Grp to the SR via dedicated signalling.

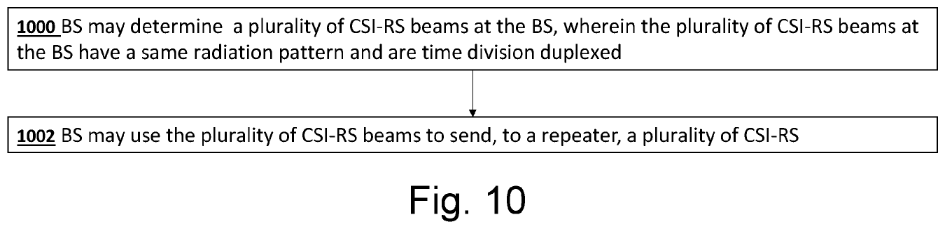

FIG. 10 shows a block diagram of a method for using a plurality of CSI-RS beams to send, by a gNB to a SR, a plurality of CSI-RS.

In step 1000, a gNB may determine a plurality of CSI-RS beams at the apparatus, wherein the plurality of CSI-RS beams at the gNB have a same radiation pattern and are time division duplexed.

In step 1002, the gNB may use the plurality of c CSI-RS beams to send, to a SR, a plurality of CSI-RS.

The plurality of CSI-RS beams at the gNB may have at least a same direction for a main lobe (i.e. steering lobe).

The plurality of CSI-RS beams at the gNB may have a same direction or different directions for side lobes.

The plurality of CSI-RS beams at the gNB may have a same gain or different gains for a main lobe (i.e. steering lobe).

The plurality of CSI-RS beams at the gNB may have a same gain or different gains for side lobes.

The gNB may perform a CSI-RS beam sweep. The gNB may receive, from the SR, a CSI-RS measurements. The gNB may determine the plurality of CSI-RS beams at the apparatus based on the CSI-RS measurements.

A number of the plurality of CSI-RS beams at the gNB may be smaller than or equal to a number of a plurality of CSI-RS beams at the SR.

The gNB may determine active CSI-RS beams at the gNB among the plurality of CSI-RS beams at the gNB. Active CSI-RS beams at the gNB may be mapped to CSI-RS beams at the SR with strongest or best CSI-RS measurements from a UE. Inactive CSI-RS beams at the gNB may be mapped to CSI-RS beams at the SR with weakest or worse CSI-RS measurements from a UE.

The gNB may use the active CSI-RS beams at the gNB to send CSI-RS, control and/or data with a lower power. The gNb may use the inactive CSI-RS beams at the apparatus to send CSI-RS, control and/or data with a higher power.

The gNB may receive, from the SR, an identifier of the SR. The gNB may use the identifier of the SR to send configuration information to the SR via dedicated signalling.

The configuration information may comprise at least one of: a TDD frame structure; a CSI-RS beam identifier for each CSI-RS beam of the plurality of CSI-RS beams at the gNB; time resources of the TDD structure allocated for each CSI-RS beam of the plurality of CSI-RS beams at the gNB; and an active tag for each CSI-RS beam of the plurality of CSI-RS beams at the gNB.

The gNB may determine a serving SSB beam at the gNB. The gNB may use the serving SSB beam at the SSB to send SSB to the SR.

The gNB may perform a SSB beam sweep; receive, from the SR, SSB beam measurements. The gNB may determine the serving SSB beam at the apparatus based on the SSB beam measurements.

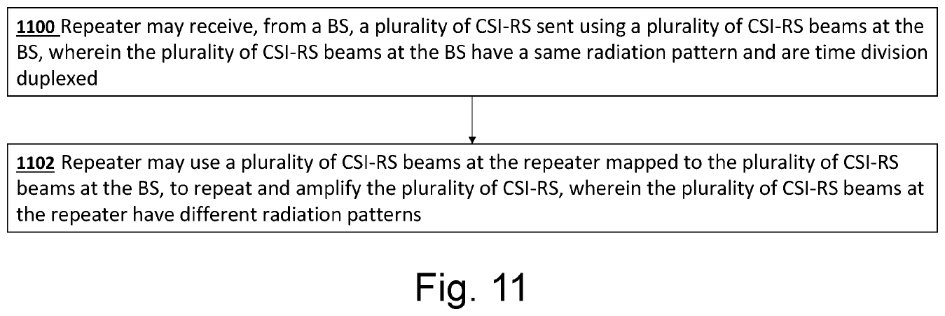

FIG. 11 shows a block diagram of a method for receiving, by a SR, a plurality of CSI-RS sent, by a gNB, using a plurality of CSI-RS beams.

In step 1100, a SR may receive, from a gNB, a plurality of CSI-RS sent using a plurality of CSI-RS beams at the gNB, wherein the plurality of CSI-RS beams at the gNB have a same radiation pattern and are time division duplexed.

In step 1102, the SR may use a plurality of CSI-RS beams at the SR mapped to the plurality of CSI-RS beams at the gNB, to repeat and amplify the plurality of CSI-RS, wherein the plurality of CSI-RS beams at the SR have different radiation patterns.

A number of the plurality of CSI-RS beams at the gNB may be smaller than or equal to a number of the plurality of CSI-RS beams at the SR.

The SR may receive, from UE, CSI-RS measurements. The SR may repeat and amplify the CSI-RS measurements to allow the gNB to determine active CSI-RS beams at the gNB. Active CSI-RS beams at the gNB may be mapped to CSI-RS beams at the SR with strongest or best CSI-RS measurements. Inactive CSI-RS beams at the gNB may be mapped to CSI-RS beams at the SR with weakest or worse CSI-RS measurements.

The SR may receive, from the gNB, CSI-RS, control and/or data sent using active CSI-RS beams at the gNB with a lower power. The SR may receive, from the gNB, CSI-RS, control and/or data sent using inactive CSI-RS beams at the base station with a higher power.

The SR may send, to the gNB, an identifier of the SR. The SR may receive configuration information from the gNB via dedicated signalling sent using the identifier of the SR.

The configuration information may comprise at least one of: a TDD frame structure; a CSI-RS beam identifier for each CSI-RS beam of the plurality of CSI-RS beams at the gNB; time resources of the TDD frame structure allocated for each CSI-RS beam of the plurality of CSI-RS beams at the gNB; and an active tag for each CSI-RS beam of the plurality of CSI-RS beams at the gNB.

The SR may receive a SSB sent using a serving SSB beam at the gNB. The SR may use a SSB beam at the SR to repeat and amplify the SSB. The SR may use the SSB beam at the SR to repeat and amplify the SSB with an omnidirectional radiation pattern. The SR may repeat and amplify RACH occasions mapped to the synchronization signal block.

The SR may receive SSB sent using a SSB beam sweep by the gNB. The SR may use a SSB beam at the apparatus to repeat and amplify the SSB. The SR may use the SSB beam at the SR to repeat and amplify the SSB with an omnidirectional radiation pattern. The SR may repeat and amplify all RACH occasions mapped to all SSB.

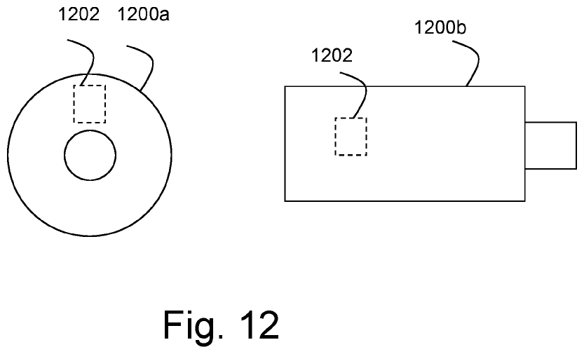

FIG. 12 shows a schematic representation of non-volatile memory media 1200a (e.g. computer disc (CD) or digital versatile disc (DVD)) and 1200b (e.g. universal serial bus (USB) memory stick) storing instructions and/or parameters 1202 which when executed by a processor allow the processor to perform one or more of the steps of the methods of FIGS. 10 and 11.

It is noted that while the above describes example embodiments, there are several variations and modifications which may be made to the disclosed solution without departing from the scope of the present invention.

It will be understood that although the above concepts have been discussed in the context of a 5GS, one or more of these concepts may be applied to other cellular systems.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 10 and 11, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1-22. (canceled)

23. An apparatus comprising at least one processor and at least one memory including computer code for one or more programs, the at least one memory and the computer code configured, with the at least one processor, to cause the apparatus at least to:
determine a plurality of channel state information reference signal beams at the apparatus, wherein the plurality of channel state information reference signal beams at the apparatus have a same radiation pattern and are time division duplexed; and
use the plurality of channel state information reference signal beams to send, to a repeater, a plurality of channel state information reference signals.

24. The apparatus of claim 23, wherein a number of the plurality of channel state information reference signal beams at the apparatus is smaller than or equal to a number of a plurality of channel state information reference signal beams at the repeater.

25. The apparatus of claim 23, wherein the at least one memory and the computer code are configured, with the at least one processor, to cause the apparatus at least to:
determine active channel state information reference signal beams at the apparatus among the plurality of channel state information reference signal beams at the apparatus,
wherein active channel state information reference signal beams at the apparatus are mapped to channel state information reference signal beams at the repeater with strongest or best channel state information reference signal measurements from a user equipment, and
wherein inactive channel state information reference signal beams at the apparatus are mapped to channel state information reference signal beams at the repeater with weakest or worse channel state information reference signal measurements from a user equipment.

26. The apparatus of claim 25, wherein the at least one memory and the computer code are configured, with the at least one processor, to cause the apparatus at least to:
use the active channel state information reference signal beams at the apparatus to send channel state information reference signals, control and/or data with a lower power; and
use the inactive channel state information reference signal beams at the apparatus to send channel state information reference signals, control and/or data with a higher power.

27. The apparatus of claim 23, wherein the at least one memory and the computer code are configured, with the at least one processor, to cause the apparatus at least to:
receive, from the repeater, an identifier of the repeater; and
use the identifier of the repeater to send configuration information to the repeater via dedicated signalling.

28. The apparatus of claim 27, wherein the configuration information comprises at least one of:
a time division duplex frame structure;
a channel state information reference signal beam identifier for each channel state information reference signal beam of the plurality of channel state information reference signal beams at the apparatus;
time resources of the time division duplex frame structure allocated for each channel state information reference signal beam of the plurality of channel state information reference signal beams at the apparatus; or
an active tag for each channel state information reference signal beam of the plurality of channel state information reference signal beams at the apparatus.

29. The apparatus of claim 23, wherein the at least one memory and the computer code are configured, with the at least one processor, to cause the apparatus at least to:
determine a serving synchronization signal block beam at the apparatus; and
use the serving synchronization signal block beam at the apparatus to send synchronization signal blocks to the repeater.

30. An apparatus comprising at least one processor and at least one memory including computer code for one or more programs, the at least one memory and the computer code configured, with the at least one processor, to cause the apparatus at least to:
receive, from a base station, a plurality of channel state information reference signals sent using a plurality of channel state information reference signal beams at the base station, wherein the plurality of channel state information reference signal beams at the base station have a same radiation pattern and are time division duplexed; and
use a plurality of channel state information reference signal beams at the apparatus mapped to the plurality of channel state information reference signal beams at the base station, to repeat and amplify the plurality of channel state information reference signals, wherein the plurality of channel state information reference signal beams at the apparatus have different radiation patterns.

31. The apparatus of claim 30, wherein a number of the plurality of channel state information reference signal beams at the base station is smaller than or equal to a number of the plurality of channel state information reference signal beams at the apparatus.

32. The apparatus of claim 30, wherein the at least one memory and the computer code are configured, with the at least one processor, to cause the apparatus at least to:
receive, from user equipment, channel state information reference signal measurements; and
repeat and amplify the channel state information reference signal measurements to allow the base station to determine active channel state information reference signal beams at the base station,
wherein active channel state information reference signal beams at the base station are mapped to channel state information reference signal beams at the apparatus with strongest or best channel state information reference signal measurements, and
wherein inactive channel state information reference signal beams at the base station are mapped to channel state information reference signal beams at the apparatus with weakest or worse channel state information reference signal measurements.

33. The apparatus of claim 32, wherein the at least one memory and the computer code are configured, with the at least one processor, to cause the apparatus at least to:
receive, from the base station, channel state information reference signals, control and/or data sent using active channel state information reference signal beams at the base station with a lower power; and
receive, from the base station, channel state information reference signals, control and/or data sent using inactive channel state information reference signal beams at the base station with a higher power.

34. The apparatus of claim 30, wherein the at least one memory and the computer code are configured, with the at least one processor, to cause the apparatus at least to:
send, to the base station, an identifier of the apparatus; and
receive configuration information from the base station via dedicated signalling sent using the identifier of the apparatus.

35. The apparatus of claim 34, wherein the configuration information comprises at least one of:
a time division duplex frame structure;
a channel state information reference signal beam identifier for each channel state information reference signal beam of the plurality of channel state information reference signal beams at the base station;
time resources of the time division duplex frame structure allocated for each channel state information reference signal beam of the plurality of channel state information reference signal beams at the base station; or
an active tag for each channel state information reference signal beam of the plurality of channel state information reference signal beams at the base station.

36. The apparatus of claim 30, wherein the at least one memory and the computer code are configured, with the at least one processor, to cause the apparatus at least to:
receive a synchronization signal block sent using a serving synchronization signal block beam at the base station; and
use a synchronization signal block beam at the apparatus to repeat and amplify the synchronization signal block.

37. The apparatus of claim 36, wherein the at least one memory and the computer code are configured, with the at least one processor, to cause the apparatus at least to:
use the synchronization signal block beam at the apparatus to repeat and amplify the synchronization signal block with an omnidirectional radiation pattern.

38. The apparatus of claim 36, wherein the at least one memory and the computer code are configured, with the at least one processor, to cause the apparatus at least to:
repeat and amplify random access channel occasions mapped to the synchronization signal block.

39. The apparatus of claim 30, wherein the at least one memory and the computer code are configured, with the at least one processor, to cause the apparatus at least to:
receive synchronization signal blocks sent using a synchronization signal block beam sweep by the base station;
use a synchronization signal block beam at the apparatus to repeat and amplify the synchronization signal blocks; and
use the synchronization signal block beam at the apparatus to repeat and amplify the synchronization signal blocks with an omnidirectional radiation pattern.

40. The apparatus of claim 39, wherein the at least one memory and the computer code are configured, with the at least one processor, to cause the apparatus at least to:
repeat and amplify all random access channel occasions mapped to all synchronization signal blocks.

41. A method comprising:
determining, by a base station, a plurality of channel state information reference signal beams at the base station, wherein the plurality of channel state information reference signal beams at the base station have a same radiation pattern and are time division duplexed; and
using, by the base station, the plurality of channel state information reference signal beams to send, to a repeater, a plurality of channel state information reference signals.

42. The method of claim 41, further comprising:
Determining, by the base station, active channel state information reference signal beams at the base station among the plurality of channel state information reference signal beams at the base station;
wherein active channel state information reference signal beams at the base station are mapped to channel state information reference signal beams at the repeater with strongest or best channel state information reference signal measurements from a user equipment, and
wherein inactive channel state information reference signal beams at the base station are mapped to channel state information reference signal beams at the repeater with weakest or worse channel state information reference signal measurements from a user equipment.
